(19) United States
(12) Patent Application Publication
(10) Pub. No.: US 2015/0310441 A1
(43) Pub. Date: Oct. 29, 2015

(54) TRANSACTION SYSTEM METHOD, ELECTRONIC SIGNATURE TOOL, AND NETWORK BANK SERVER AUTHENTICATION

(71) Applicant: TENDYRON CORPORATION, Beijing (CN)

(72) Inventor: Dongsheng LI, Beijing (CN)

(73) Assignee: Tendyron Corporation, Beijing (CN)

(21) Appl. No.: 14/439,966

(22) PCT Filed: Oct. 30, 2013
(86) PCT No.: PCT/CN2013/086212

§ 371 Date: Apr. 30, 2015

(30) Foreign Application Priority Data
Oct. 31, 2012 (CN) 201210428909.8

(51) Int. Cl. G06Q 20/40; G06Q 40/04

(52) U.S. Cl. CPC G06Q 20/4014; G06Q 40/04

(57) ABSTRACT

The present invention provides a transaction system and method, an electronic signature tool, and a network bank server authentication method. The system comprises: a telephone terminal, for receiving personal information entered by a user; a telephone bank server, for receiving the personal information sent by the telephone terminal and verifying the personal information, and receiving, after the verification succeeds, transaction information and an authentication password that are entered by the user; a network bank server, for receiving the transaction information and the authentication password that are sent by the telephone bank server, and performing encryption calculation on the transaction information according to the authentication password to generate authentication information; a network terminal, for acquiring the transaction information and authentication information from the network bank server; and an electronic signature tool, for receiving the transaction information and authentication information that are sent by the network terminal, verifying the transaction information and authentication information, and generating, after the verification succeeds, signature data of the transaction information and sending the signature data to the network bank server. The present invention reduces the transaction complexity, ensures the security, and facilitates the operation.

### FIELD

The present invention relates to an information security technology field, and more particularly to a trading system, an electronic signature token, a trading method and an authentication method for a network bank server.

### BACKGROUND

Currently, when a user makes a trade by using a telephone, the user can interact with a telephone bank server via the telephone by inputting a user ID and a password, and then the telephone bank server receives trade information and an authentication password input by the user if a verification on the user ID and the password is successful. Therefore, as long as the user ID and the passwords are obtained, a transfer of account can be completed. This is convenient to use, but lacks security.

When making a trade via an Internet bank, the user uses an electronic signature token (for example a USB key) to ensure the security of the trade. However, the Internet bank has high requirements for hardware. For special populations, operations related to Internet bank are extremely inconvenient, for example, people having no computer or using an unsafe public computer, or the elderly who do not know how to use the Internet. Thus, there is an urgent need for a trading method which is both convenient and secure.

### SUMMARY

Embodiments of the present invention seek to solve at least one of the problems existing in the related art.

In order to achieve the above objectives, a first objective of the present disclosure is to provide a trading system, comprising: a telephone terminal, configured to receive personal information input by a user and to send the personal information; a telephone bank server, configured to receive the personal information sent by the telephone terminal, and to perform a verification to the personal information, and to receive trade information and an authentication password input by the user if the verification is successful, and to send the trade information and the authentication password; a network bank server, configured to receive the trade information and the authentication password sent by the telephone bank server, and to encrypt the trade information according to the authentication password to generate authentication information; a network terminal, configured to obtain the trade information and the authentication information from the network bank server; an electronic signature token, configured to receive the trade information and the authentication information sent by the network terminal, and to perform a verification to the trade information and the authentication information, and to generate signature data of the trade information if the verification is successful and to send the signature data to the network bank server; wherein the network bank server is further configured to perform an authentication to the signature data and to complete a trade if the authentication is successful.

With the trading system according to embodiments of the present disclosure, a combination of the telephone bank server and the network bank server can be realized, and the user submits personal information, the trade information and the authentication password to the telephone bank server via the telephone terminal, the user owns the personal information and the authentication password independently, then the telephone bank server submits the trade information and the authentication password to the network bank server, the network bank server and electronic signature token perform an authentication to the trade information and the authentication information, and the authentication party uses the electronic signature token to complete the authentication without inputting a password, thereby ensuring that the authentication party cannot complete the trade on his own and improving the trade security. Meanwhile the user can make a trade via the telephone terminal in unsatisfactory hardware conditions, which reduces the trade complexity and ensures the trade security, and is convenient to use and easy to operate.

In order to achieve the above objectives, a second objective of the present disclosure is to provide an electronic signature token, comprising: a storing module, configured to store a preset authentication password and a preset encryption algorithm; a receiving-transmitting module, configured to receive trade information and authentication information sent by a network bank server; an encrypting module, configured to encrypt the trade information with the preset encryption algorithm according to the preset authentication password to generate checking information; a verifying module, configured to compare the checking information and the authentication information, and to determine that a verification to the trade information and the authentication information is successful if the checking information is consistent with the authentication information.

With the electronic signature token according to embodiments of the present disclosure, the encrypting module encrypts the trade information sent by the network bank server with the preset encryption algorithm to generate the checking information, and the verifying module performs a verification by comparing the checking information with the authentication information sent by the network bank server, such that the electronic signature token can realize the authentication operation of the network bank server, and the authentication party can complete a trade by performing signing and confirming operations without knowing the authentication password, which greatly improves the security of the electronic trade, and is convenient to use and easy to operate.

In order to achieve the above objectives, a third objective of the present disclosure is to provide a trading method, comprising: receiving by a telephone bank server personal information sent by a user via a telephone terminal; performing by the telephone bank server a verification to the personal information, and receiving by the telephone bank server trade information and an authentication password input by the user if the verification is successful; sending by the telephone bank server the trade information and the authentication password to a network bank server; encrypting by the network bank server the trade information according to the authentication password to generate authentication information, and providing an indication by the network bank server for an authenticating party according to the trade information; obtaining by the authenticating party the trade information and the authentication information from the network bank server via a network terminal according to the indication, and using by the authenticating party an electronic signature token to perform a verification to the trade information and the authentication information; generating by the electronic signature token signature data of the trade information if the verification is successful, and sending by the electronic signature token the signature data to the network bank server; performing by the network bank server an authentication to the signature data and completing a trade by the network bank server if the authentication is successful.

With the trading method according to embodiments of the present disclosure, a combination of the telephone bank server and the network bank server can be realized, and the user submits personal information, the trade information and the authentication password to the telephone bank server via the telephone terminal, the user owns the personal information and the authentication password independently, then the telephone bank server submits the trade information and the authentication password to the network bank server, the network bank server and electronic signature token perform an authentication to the trade information and the authentication information, and the authentication party uses the electronic signature token to complete the authentication without inputting a password, thereby ensuring that the authentication party cannot complete the trade on his own and improving the trade security. Meanwhile the user can make a trade via the telephone terminal in unsatisfactory hardware conditions, which reduces the trade complexity and ensures the trade security, and is convenient to use and easy to operate.

In order to achieve the above objects, a fourth objective of the present disclosure is to provide an authentication method for a network bank server, comprising: receiving by the network bank server trade information and an authentication password sent by a telephone bank server, and encrypting by the network bank server the trade information according to the authentication password to generate authentication information; sending by the network bank server the trade information and the authentication information to an electronic signature token via a network terminal; encrypting by the electronic signature token the trade information according to a prestored authentication password to generate checking information; judging by the electronic signature token whether the checking information is consistent with the authentication information; determining by the electronic signature token that an authentication to the network bank server is successful if the checking information is consistent with the authentication information.

With the authentication method for a network bank server according to embodiments of the present disclosure, a consistency between the authentication information generated by the network bank server and the checking information generated by the electronic signature token is compared to judge whether the authentication to the network bank server is successful, which greatly improves the security of the electronic trade, needs no user operation, and is convenient to use.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the accompanying drawings, in which:

FIG. 1 is a schematic diagram of a trading system according to an embodiment of the present disclosure; and

FIG. 2 is a schematic diagram of an electronic signature token according to an embodiment of the present disclosure;

FIG. 3 is a schematic diagram of an electronic signature token according to another embodiment of the present disclosure;

FIG. 4 is a flow chart of a trading method according to an embodiment of the present disclosure;

FIG. 5 is a flow chart of a trading method according to another embodiment of the present disclosure;

FIG. 6 is a flow chart of a trading method according to yet another embodiment of the present disclosure;

FIG. 7 is a flow chart of a trading method according to a specific embodiment of the present disclosure; and

FIG. 8 is a flow chart of an authentication method for a network bank server according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure. In turn, embodiments of the present disclosure include all variants, modifications and equivalents fallen in the spirit and extent of the attached claims.

In addition, terms such as “first” and “second” are used herein for purposes of description and are not intended to indicate or imply relative importance or significance. In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure. In addition, in the description of the present disclosure, “a plurality of” means two or more than two, unless specified otherwise.

Any process or method described in the flowing diagram or other means may be understood as a module, segment or portion including one or more executable instruction codes of the procedures configured to achieve a certain logic function or process, and the preferred embodiments of the present disclosure include other performances, in which the performance may be achieved in other orders instead of the order shown or discussed, such as in a almost simultaneous way or in an opposite order, which should be appreciated by those having ordinary skills in the art to which embodiments of the present disclosure belong.

In the following, a trading system, an electronic signature token, a trading method and an authentication method for a network bank server according to embodiments of the present disclosure will be described in detail with reference to the drawings.

FIG. 1 is a schematic diagram of a trading system according to an embodiment of the present disclosure.

As shown in FIG. 1, the trading system according to an embodiment of the present disclosure includes a telephone terminal 100, a telephone bank server 200, a network bank server 300, a network terminal 400 and an electronic signature token 500, in which the electronic signature token 500 may be secret key device, such as a USB key.

Specifically, the telephone terminal 100 is configured to receive personal information input by a user and to send the personal information. The user inputs the personal information via the telephone terminal 100 to log in the telephone bank server 200.

The telephone bank server 200 is configured to receive the personal information sent by the telephone terminal 100, and to perform a verification to the personal information, and to receive trade information and an authentication password input by the user if the verification is successful, and to send the trade information and the authentication password. For example, after the telephone bank server 200 performs the verification to the personal information, the telephone bank server 200 prompts the user to select a business option via the telephone terminal 100. For example, if the user select a business option of money transfer, the telephone bank server 200 prompts the user to input a transfer account, a transfer amount and an authentication password, in which the transfer account and the transfer amount are included in the trade information.

The network bank server 300 is configured to receive the trade information and the authentication password sent by the telephone bank server 200, and to encrypt the trade information according to the authentication password to generate authentication information. The trade information and the authentication password sent by the telephone bank server 200 to the network bank server 300 can be encrypted by using rich resources of the network bank server 300 to ensure security of a transaction. A step that the network bank server 300 encrypts the trade information according to the authentication password to generate the authentication information may be performed with Hash encryption algorithm and any other encryption algorithms.

The network terminal 400 is configured to obtain the trade information and the authentication information from the network bank server 300. The network terminal 400 may include at least one of a smart phone, a tablet computer, a notebook computer, a personal computer.

The electronic signature token 500 is configured to receive the trade information and the authentication information sent by the network terminal 400, and to perform a verification to the trade information and the authentication information, and to generate signature data of the trade information if the verification is successful and to send the signature data to the network bank server 300. More specifically, the electronic signature token 500 receives the trade information and the authentication information, and then the electronic signature token 500 displays the trade information on screen for an authenticating party to confirm. If the authenticating party confirms that the trade information is correct, the authenticating party can press a confirmation button of the electronic signature token 500 to complete a confirming operation, and the authenticating party sends the signature data via the electronic signature token 500 to complete the trade. After the network bank server 300 receives the signature data, the network bank server 300 is further configured to perform an authentication to the signature data and to complete the trade if the authentication is successful, in other words, the network bank server 300 performs the trade according to the signature data sent by the electronic signature token 500.

With the trading system according to embodiments of the present disclosure, a combination of the telephone bank server and the network bank server can be realized, and the user submits personal information, the trade information and the authentication password to the telephone bank server via the telephone terminal, the user owns the personal information and the authentication password independently, then the telephone bank server submits the trade information and the authentication password to the network bank server, the network bank server and electronic signature token perform an authentication to the trade information and the authentication information, and the authentication party uses the electronic signature token to complete the authentication without inputting a password, thereby ensuring that the authentication party cannot complete the trade on his own and improving the trade security. Meanwhile the user can make a trade via the telephone terminal in unsatisfactory hardware conditions, which reduces the trade complexity and ensures the trade security, and is convenient to use and easy to operate. In other words, the trading system according to embodiments of the present disclosure applies the network bank server and a certificate to improve the trade security, without increasing the operation complexity of the telephone bank server.

In an embodiment of the present disclosure, the electronic signature token 500 is further configured to send verification failure information to the network bank server 300 if a verification to the network bank server 300 is unsuccessful. Thereby, the verification failure information can be sent to the network bank server 300 timely if the verification to the trade information and the authentication information is unsuccessful, which prevents the user from making a mistake trade, and ensures the trade security.

In an embodiment of the present disclosure, the network bank server 300 is further configured to send a trade result to the telephone bank server 200 if the verification to the network bank server 300 is unsuccessful or if the trade is completed, and the authentication party can log in a platform corresponding to the telephone bank server 200 to query; and the telephone bank server 200 is further configured to send the trade result to the telephone terminal 100 to notify the user, for example, sending a text message to the user to notify. Thereby, if the verification to the network bank server 300 is unsuccessful or if the trade is completed or successful, the telephone bank server 200 can provide the user trade information in time. As the telephone bank server 200 provides the trade information to the authentication part in time, the security of the electronic trade can be further improved.

In yet another embodiment of the present disclosure, the electronic signature token 400 is further configured to store a preset authentication password, and to encrypt the trade information with a preset encryption algorithm according to the preset authentication password to generate checking information, and to compare the checking information with the authentication information, and to determine that a verification to the trade information and the authentication information is successful if the checking information is consistent with the authentication information. The authentication password is a password input to the telephone bank server 200 by the user. By performing an authentication of the authentication information via the preset authentication password, only the user knows the authentication password, thus ensuring the trade security. In addition, the preset encryption algorithm is matched with an encryption algorithm used in the network bank server 300, and may be the Hash encryption algorithm. With the preset authentication password as a secret key, an irreversible hash value of the trade information can be calculated with the preset encryption algorithm to generate the checking information. Thereby, the electronic signature token 500 completes the authentication to the network bank server 300, which ensures that the completed trade is from a reliable server and further improves the security.

In order to achieve the above-described embodiments, the present disclosure further provides an electronic signature token.

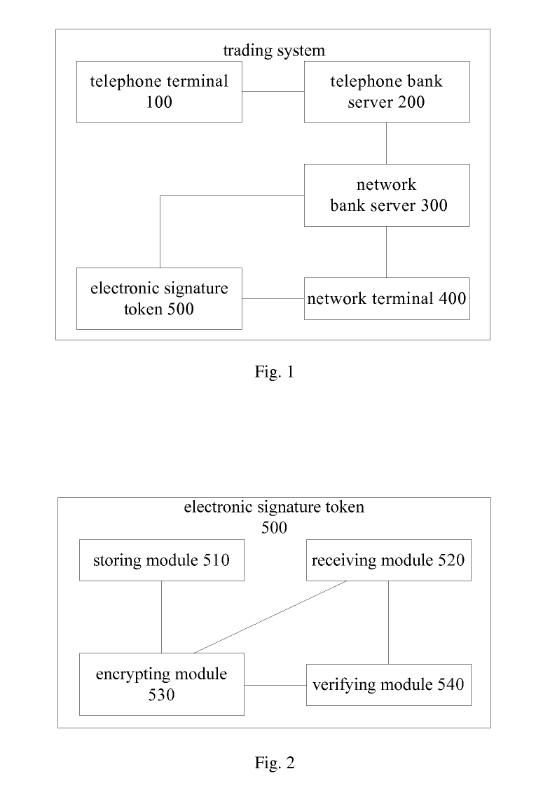

FIG. 2 is a schematic diagram of an electronic signature token according to an embodiment of the present disclosure.

As shown in FIG. 2, the electronic signature token 500 according to embodiments of the present disclosure includes a storing module 510, a receiving-transmitting module 520, an encrypting module 530 and a verifying module 540. The electronic signature token 500 may be a secret key device, such as a USB key.

Specifically, the storing module 510 is configured to store a preset authentication password and a preset encryption algorithm. The preset authentication password can be updated on a network bank server or can be updated by the user via a telephone terminal.

The receiving-transmitting module 520 is configured to receive trade information and authentication information sent by the network bank server.

The encrypting module 530 is configured to encrypt the trade information with the preset encryption algorithm according to the preset authentication password to generate checking information. More specifically, the preset authentication password is matched with an encryption algorithm used in the network bank server, which can be Hash encryption algorithm or other encryption algorithms. With the preset encryption algorithm as a secret key, an irreversible Hash value of the trade information can be calculated with the preset encryption algorithm to generate the checking information.

The verifying module 540 is configured to compare the checking information with the authentication information, and to determine that a verification to the trade information and the authentication information is successful if the checking information is consistent with the authentication information.

With the electronic signature token according to embodiments of the present disclosure, the encrypting module encrypts the trade information sent by the network bank server with the preset encryption algorithm to generate the checking information, and the verifying module performs a verification by comparing the checking information with the authentication information sent by the network bank server, such that the electronic signature token can realize the authentication operation of the network bank server, and the authentication party can complete a trade by performing signing and confirming operations without knowing the authentication password, which greatly improves the security of the electronic trade, and is convenient to use and easy to operate.

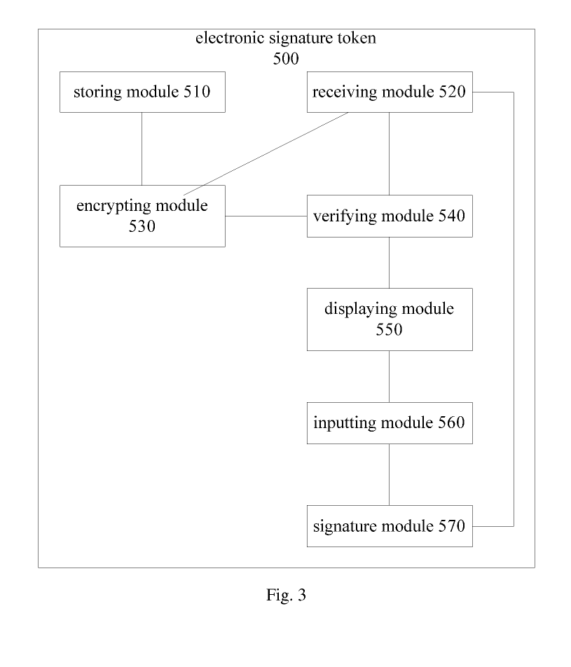

FIG. 3 is a schematic diagram of an electronic signature token according to another embodiment of the present disclosure.

As shown in FIG. 3, based on embodiments of the present disclosure shown in FIG. 2, the electronic signature token 500 according to the embodiments of the present disclosure further includes a displaying module 550, an inputting module 560 and a signature module 570.

Specifically, the displaying module 550 is configured to display the trade information if the verifying module 530 determines that a verification to the trade information and the authentication information is successful. This facilitates the authentication party to confirm the trade information and to operate according to the trade information.

The inputting module 560 is configured to receive a confirming instruction input by the user if the user confirms that the trade information is correct. For example, the confirming instruction is used to confirm the trade or cancel the trade.

The signature module 570 is configured to generate signature data of the trade information if the inputting module 560 receives the confirming instruction and to send the signature data to the network bank server via the receiving-transmitting module 520 to complete the trade. For example, if the user inputs the confirming instruction, the signature data is generated to complete the trade.

With the electronic signature token according to embodiments of the present disclosure, the displaying module displays the trade information, which facilitates the user to confirm the trade information, and a signature module generates the signature data of the trade information and provides the signature data to the network bank server for authenticating. In this way, the security of the electronic trade can be further improved, and the operation for the user can be more simple and convenient.

In order to achieve the above-described embodiments, the present disclosure further provides a trading method.

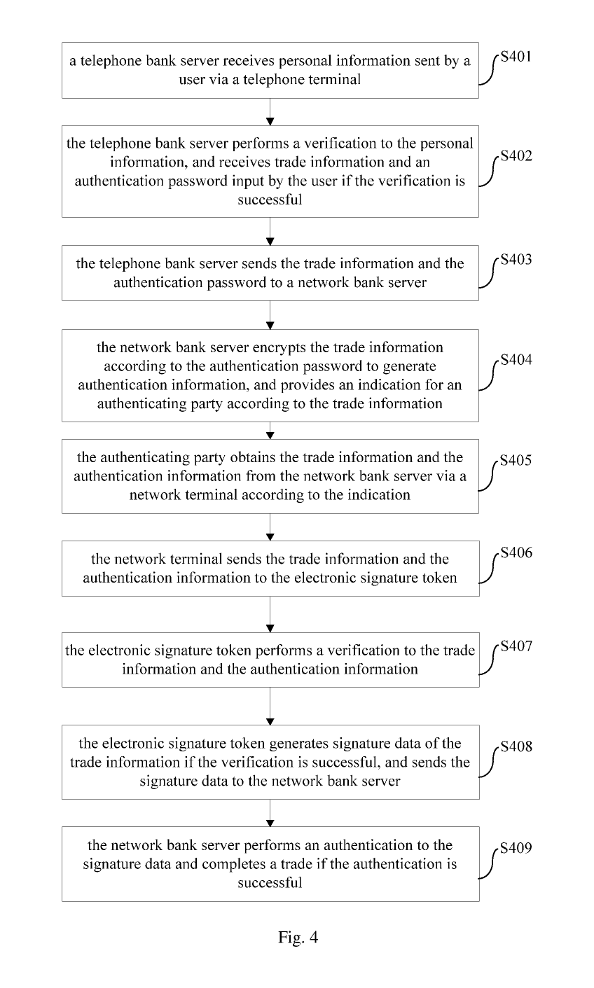

FIG. 4 is a flow chart of a trading method according to an embodiment of the present disclosure.

As shown in FIG. 4, the trading method according to embodiments of the present disclosure includes the following steps.

At step S401, a telephone bank server receives personal information sent by a user via a telephone terminal, in which the user inputs the personal information via the telephone terminal to log in the telephone bank server.

At step S402, the telephone bank server performs a verification to the personal information, and receives trade information and an authentication password input by the user if the verification is successful. For example, after the telephone bank server performs the verification to the personal information, the telephone bank server prompts the user to select a business option via the telephone terminal. If the user selects a business option of money transfer, the telephone bank server prompts the user to input a transfer account, a transfer amount and an authentication password, in which the transfer account and the transfer amount are included in the trade information.

At step S403, the telephone bank server sends the trade information and the authentication password to a network bank server. The trade information and the authentication password sent by the telephone bank server to the network bank server can be encrypted by using rich resources of the network bank server to ensure security of a transaction.

At step S404, the network bank server encrypts the trade information according to the authentication password to generate authentication information, and provides an indication for an authenticating party according to the trade information. For example, the authenticating party can log in a platform corresponding to the telephone bank server to obtain the trade information, or the telephone bank server sends a text message to the authenticating party to notify the authenticating party.

At step S405, the authenticating party obtains the trade information and the authentication information from the network bank server via a network terminal according to the indication, in which the network terminal may include at least one of a smart phone, a tablet computer, a notebook computer, a personal computer.

At step S406, the network terminal sends the trade information and the authentication information to the electronic signature token.

At step S407, the electronic signature token performs a verification to the trade information and the authentication information. Specifically, the electronic signature token encrypts the trade information with a preset encryption algorithm according to a preset authentication password to generate checking information, and compares the checking information with authentication information, and determines that the verification to the trade information and the authentication information is successful if the checking information is consistent with the authentication information.

At step S408, the electronic signature token generates signature data of the trade information if the verification is successful, and sends the signature data to the network bank server.

At step S409, the network bank server performs an authentication to the signature data and completes a trade if the authentication is successful.

With the trading method according to embodiments of the present disclosure, a combination of the telephone bank server and the network bank server can be realized, and the user submits personal information, the trade information and the authentication password to the telephone bank server via the telephone terminal, the user owns the personal information and the authentication password independently, then the telephone bank server submits the trade information and the authentication password to the network bank server, the network bank server and electronic signature token perform an authentication to the trade information and the authentication information, and the authentication party uses the electronic signature token to complete the authentication without inputting a password, thereby ensuring that the authentication party cannot complete the trade on his own and improving the trade security. Meanwhile the user can make a trade via the telephone terminal in unsatisfactory hardware conditions, which reduces the trade complexity and ensures the trade security, and is convenient to use and easy to operate.

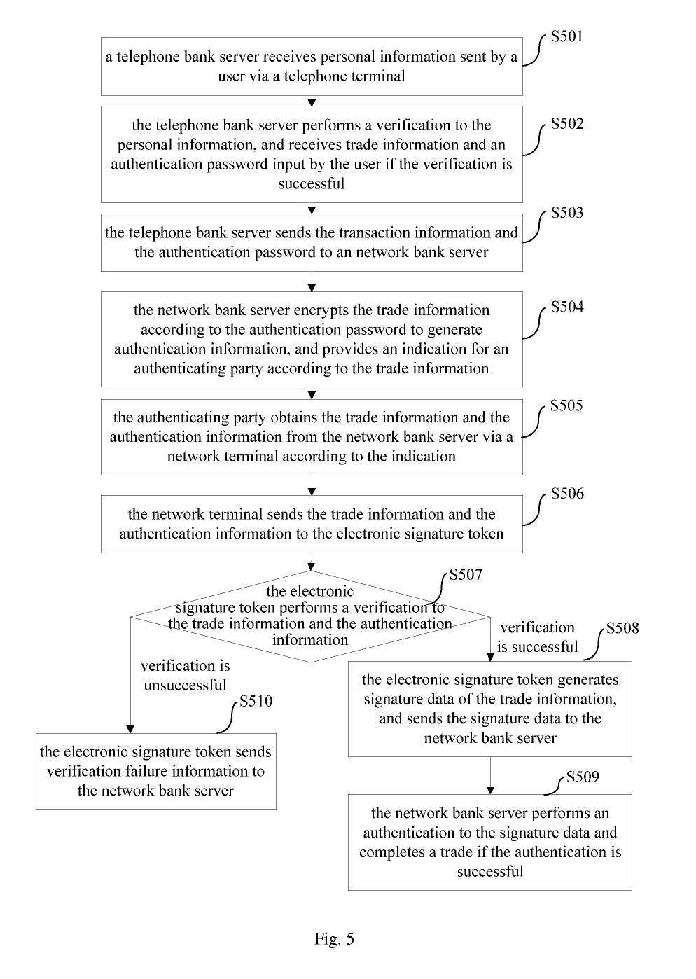

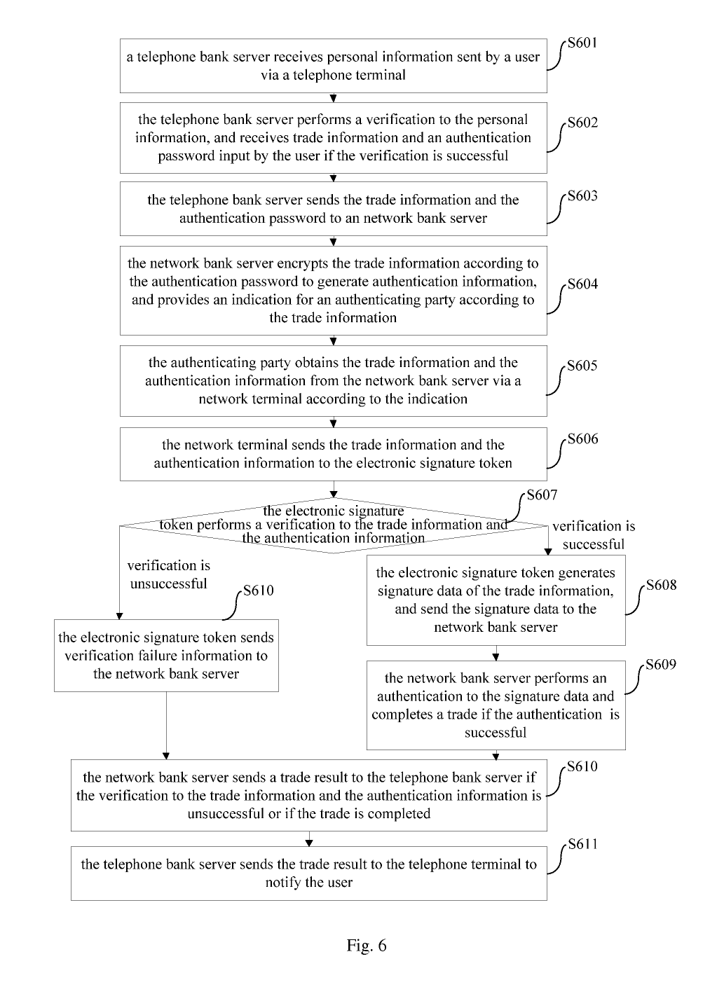

FIG. 5 is a flow chart of a trading method according to another embodiment of the present disclosure.

As shown in FIG. 5, the trading method according to embodiments of the present disclosure includes the following steps.

At step S501, a telephone bank server receives personal information sent by a user via a telephone terminal.

At step S502, the telephone bank server performs a verification to the personal information, and receives trade information and an authentication password input by the user if the verification is successful.

At step S503, the telephone bank server sends the trade information and the authentication password to a network bank server.

At step S504, the network bank server encrypts the trade information according to the authentication password to generate authentication information, and provides an indication for an authenticating party according to the trade information.

At step S505, the authenticating party obtains the trade information and the authentication information from the network bank server via a network terminal according to the indication.

At step S506, the network terminal sends the trade information and the authentication information to the electronic signature token.

At step S507, the electronic signature token performs a verification to the trade information and the authentication information.

At step S508, the electronic signature token generates signature data of the trade information if the verification is successful, and sends the signature data to the network bank server.

At step S509, the network bank server performs an authentication to the signature data and completes a trade if the authentication is successful.

At step S510, the electronic signature token sends verification failure information to the network bank server if the verification to the trade information and the authentication information is unsuccessful.

With the trading method according to embodiments of the present disclosure, verification failure information can be sent to the network bank server immediately if the verification to the trade information and the authentication information is unsuccessful, which prevents the user to make a mistake trade and ensures the trade security.

FIG. 6 is a flow chart of a trading method according to yet another embodiment of the present disclosure.

As shown in FIG. 6, the trading method according to embodiments of the present disclosure includes the following steps.

At step S601, a telephone bank server receives personal information sent by a user via a telephone terminal.

At step S602, the telephone bank server performs a verification to the personal information, and receives trade information and an authentication password input by the user if the verification is successful.

At step S603, the telephone bank server sends the trade information and the authentication password to a network bank server.

At step S604, the network bank server encrypts the trade information according to the authentication password to generate authentication information, and provides an indication for an authenticating party according to the trade information.

At step S605, the authenticating party obtains the trade information and the authentication information from the network bank server via a network terminal according to the indication.

At step S606, the network terminal sends the trade information and the authentication information to the electronic signature token.

At step S607, the electronic signature token performs a verification to the trade information and the authentication information.

At step S608, the electronic signature token generates signature data of the trade information if the verification is successful, and sends the signature data to the network bank server.

At step S609, the network bank server performs an authentication to the signature data and completes a trade if the authentication is successful.

At step S610, the electronic signature token sends verification failure information to the network bank server if the verification to the trade information and the authentication information is unsuccessful.

At step S611, the network bank server sends a trade result to the telephone bank server if the verification to the trade information and the authentication information is unsuccessful or if the trade is completed. The authenticating party can log in a platform corresponding to the telephone bank server to query.

At step S612, the telephone bank server sends the trade result to the telephone terminal to notify the user. For example, the telephone bank server notifies the user by a text message.

In an embodiment of the present disclosure, the step S610 is alternative.

With the trading method according to embodiments of the present disclosure, if the verification is unsuccessful or if the trade is completed or successful, the trade result can be sent to the telephone terminal in time to notify the user, and the trade result can be sent to the telephone bank server for the authentication party to obtain, thus further ensuring the security of the electronic trade.

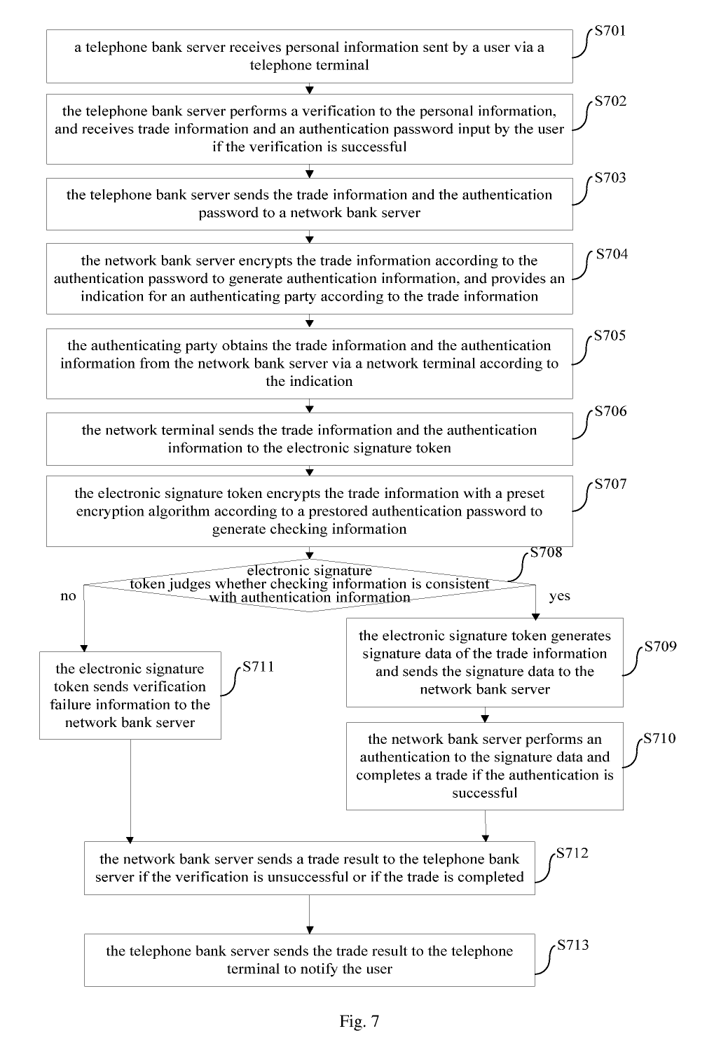

FIG. 7 is a flow chart of a trading method according to a specific embodiment of the present disclosure.

As shown in FIG. 7, the trading method according to embodiments of the present disclosure includes the following steps.

At step S701, a telephone bank server receives personal information sent by a user via a telephone terminal.

At step S702, the telephone bank server performs a verification to the personal information, and receives trade information and an authentication password input by the user if the verification is successful.

At step S703, the telephone bank server sends the trade information and the authentication password to a network bank server.

At step S704, the network bank server encrypts the trade information according to the authentication password to generate authentication information, and provides an indication for an authenticating party according to the trade information.

At step S705, the authenticating party obtains the trade information and the authentication information from the network bank server via a network terminal according to the indication.

At step S706, the network terminal sends the trade information and the authentication information to the electronic signature token.

At step S707, the electronic signature token encrypts the trade information with a prestored encryption algorithm according to a preset authentication password to generate checking information.

Specifically, the preset encryption algorithm is matched with an encryption algorithm used in the network bank server, and may be Hash encryption algorithm or any other encryption algorithms. With the preset encryption algorithm as a secret key, an irreversible Hash value of the trade information can be calculated with the preset encryption algorithm to generate the checking information.

At step S708, the electronic signature token judges whether the checking information is consistent with the authentication information.

At step S709, the electronic signature token determines that a verification to the checking information and the authentication information is successful if the checking information is consistent with the authentication information, and generates signature data of the trade information and sends the signature data to the network bank server.

At step S710, the network bank server performs an authentication to the signature data and completes a trade if the authentication is successful.

At step S711, the electronic signature token determines that the verification to the checking information and the authentication information is unsuccessful if the checking information is inconsistent with the authentication information, and sends verification failure information to the network bank server.

At step S712, the network bank server sends a trade result to the telephone bank server if the verification is unsuccessful or if the trade is completed. The authenticating party can log in a platform corresponding to the telephone bank server to query.

At step S713, the telephone bank server sends the trade result to the telephone terminal to notify the user. For example, the telephone bank server sends a text message to notify the user.

In an embodiment of the present disclosure, the step S711 is alternative.

In an embodiment of the present disclosure, the steps S712 and S713 are alternative.

With the trading method according to embodiments of the present disclosure, the electronic signature token encrypts the trade information to generate the checking information, performs an authentication by comparing the checking information with the authentication information, which further improves the security of data transmission.

In order to achieve the above-described embodiments, the present disclosure further provides an authentication method for a network bank server.

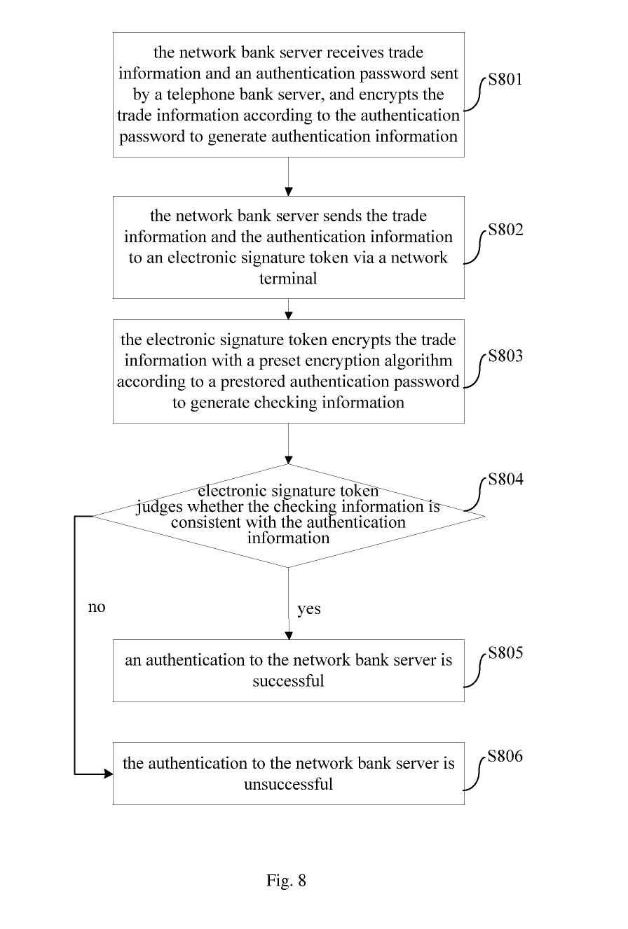

FIG. 8 is a flow chart of an authentication method for a network bank server according to an embodiment of the present disclosure.

As shown in FIG. 8, the authentication method for a network bank server according to embodiments of the present disclosure includes the following steps.

At step S801, the network bank server receives trade information and an authentication password sent by a telephone bank server, and encrypts the trade information according to the authentication password to generate authentication information.

Specifically, firstly the user sends personal information to the telephone bank server via a telephone terminal, and sends the trade information and the authentication password to the telephone bank server via the telephone terminal, and then the telephone bank server sends the trade information and the authentication password to the network bank server.

At step S802, the network bank server sends the trade information and the authentication information to an electronic signature token via a network terminal, in which the network terminal may include at least one of a smart phone, a tablet computer, a notebook computer, a personal computer.

At step S803, the electronic signature token encrypts the trade information with a prestored encryption algorithm according to a preset authentication password to generate checking information.

Specifically, the preset encryption algorithm is matched with an encryption algorithm used in the network bank server, and may be Hash encryption algorithm or other encryption algorithms. With the preset authentication password a secret key, an irreversible Hash value of the trade information can be calculated with the Hash encryption algorithm to generate the checking information.

At step S804, the electronic signature token judges whether the checking information is consistent with the authentication information.

At step S805, the electronic signature token determines that an authentication to the network bank server is successful if the checking information is consistent with the authentication information.

At step S806, the electronic signature token determines that the authentication to the network bank server is unsuccessful if the checking information is inconsistent with the authentication information.

With the authentication method for a network bank server according to embodiments of the present disclosure, a consistency between the authentication information generated by the network bank server and the checking information generated by the electronic signature token is compared to judge whether the authentication to the network bank server is successful, which greatly improves the security of the electronic trade, needs no user operation, and is easy to use.

Although explanatory embodiments have been shown and described, it would be appreciated by those skilled in the art that the above embodiments cannot be construed to limit the present invention, and changes, alternatives, and modifications can be made in the embodiments without departing from spirit, principles and scope of the present invention.

What is claimed is:

1. A trading system, comprising:
a telephone terminal, configured to receive personal information input by a user and to send the personal information;
a telephone bank server, configured to receive the personal information sent by the telephone terminal, and to perform a verification to the personal information, and to receive trade information and an authentication password input by the user if the verification is successful, and to send the trade information and the authentication password;
a network bank server, configured to receive the trade information and the authentication password sent by the telephone bank server, and to encrypt the trade information according to the authentication password to generate authentication information;
a network terminal, configured to obtain the trade information and the authentication information from the network bank server;
an electronic signature token, configured to receive the trade information and the authentication information sent by the network terminal, and to perform a verification to the trade information and the authentication information, and to generate signature data of the trade information if the verification is successful and to send the signature data to the network bank server;
wherein the network bank server is further configured to perform an authentication to the signature data and to complete a trade if the authentication is successful.

2. The trading system according to claim 1, wherein the electronic signature token is further configured to send verification failure information to the network bank server if the verification to the trade information and the authentication information is unsuccessful.

3. The trading system according to claim 1 or 2, wherein the network bank server is further configured to send a trade result to the telephone bank server if the verification to the trade information and the authentication information is unsuccessful or if the trade is completed; and the telephone bank server is further configured to send the trade result to the telephone terminal to notify the user.

4. The trading system according to claim 1, wherein the electronic signature token is further configured to store a preset authentication password, and to encrypt the trade information with a preset encryption algorithm according to the preset authentication password to generate checking information, and to compare the checking information and the authentication information, and to determine that the verification to the trade information and the authentication information is successful if the checking information is consistent with the authentication information.

5. The trading system according to claim 1 or 4, wherein the preset encryption algorithm used in the electronic signature token and an encryption algorithm used in the network bank server are matched with each other.

6. An electronic signature token, comprising:
a storing module, configured to store a preset authentication password and a preset encryption algorithm;
a receiving-transmitting module, configured to receive trade information and authentication information sent by a network bank server;
an encrypting module, configured to encrypt the trade information with the preset encryption algorithm according to the preset authentication password to generate checking information;
a verifying module, configured to compare the checking information and the authentication information, and to determine that a verification to the trade information and the authentication information is successful if the checking information is consistent with the authentication information.

7. The electronic signature token according to claim 6, further comprising:
a displaying module, configured to display the trade information if the verifying module determines that a verification to the trade information and the authentication information is successful;
an inputting module, configured to receive a confirming instruction input by a user if the user confirms that the trade information is correct;
a signature module, configured to generate signature data of the trade information if the inputting module receives the confirming instruction.

8. The electronic signature token according to claim 6, wherein the preset encryption algorithm used in the electronic signature token and an encryption algorithm used in the network bank server are matched with each other.

9. A trading method, comprising:
receiving by a telephone bank server personal information sent by a user via a telephone terminal;
performing by the telephone bank server a verification to the personal information, and receiving by the telephone bank server trade information and an authentication password input by the user if the verification is successful;
sending by the telephone bank server the trade information and the authentication password to a network bank server;
encrypting by the network bank server the trade information according to the authentication password to generate authentication information, and providing an indication by the network bank server for an authenticating party according to the trade information;
obtaining by the authenticating party the trade information and the authentication information from the network bank server via a network terminal according to the indication, and using by the authenticating party an electronic signature token to perform a verification to the trade information and the authentication information;
generating by the electronic signature token signature data of the trade information if the verification is successful, and sending by the electronic signature token the signature data to the network bank server;
performing by the network bank server an authentication to the signature data and completing a trade by the network bank server if the authentication is successful.

10. The method according to claim 9, further comprising:
sending by the electronic signature token verification failure information to the network bank server if the verification to the trade information and the authentication information is unsuccessful.

11. The method according to claim 9 or 10, further comprising:
sending by the network bank server a trade result to the telephone bank server if the verification to the trade information and the authentication information is unsuccessful or if the trade is completed;
sending by the telephone bank server the trade result to the telephone terminal to notify the user.

12. The method according to claim 9, wherein verifying by an electronic signature token the trade information and the authentication information comprises:
encrypting by the electronic signature token the trade information with a preset encryption algorithm according to a prestored authentication password to generate checking information;
judging by the electronic signature token whether the checking information is consistent with the authentication information;
determining by the electronic signature token that a verification to the trade information and the authentication information is successful if the checking information is consistent with the authentication information.

13. The method according to claim 9 or 12, wherein the preset encryption algorithm used in the electronic signature token and an encryption algorithm used in the network bank server are matched with each other.

14. An authentication method for a network bank server, comprising:
receiving by the network bank server trade information and an authentication password sent by a telephone bank server, and encrypting by the network bank server the trade information according to the authentication password to generate authentication information;
sending by the network bank server the trade information and the authentication information to an electronic signature token via a network terminal;
encrypting by the electronic signature token the trade information with a preset encryption algorithm according to a prestored authentication password to generate checking information;
judging by the electronic signature token whether the checking information is consistent with the authentication information;
determining by the electronic signature token that an authentication to the network bank server is successful if the checking information is consistent with the authentication information.

15. The method according to claim 14, wherein the preset encryption algorithm used in the electronic signature token and an encryption algorithm used in the network bank server are matched with each other.
